(19) United States
(12) Patent Application Publication
(10) Pub. No.: US 2022/0133049 A1
(43) Pub. Date: May 5, 2022

(54) BED WITH MULTIPLE SEPARABLE SEGMENTS

(71) Applicant: JIAXING SINO HARDWARE MANUFACTURING COMPANY LIMITED, Jiaxing (CN)

(72) Inventor: Klaus Bellingroth, Gummersbach (DE)

(73) Assignee: JIAXING SINO HARDWARE MANUFACTURING COMPANY LIMITED, Jiaxing (CN)

(21) Appl. No.: 17/102,330

(22) Filed: Nov. 23, 2020

(30) Foreign Application Priority Data
Oct. 30, 2020 (CN) 2020111963446

(51) Int. Cl. A47C 19/04; A47C 19/02; A47C 19/00; A47C 20/04

(52) U.S. Cl. CPC A47C 19/045; A47C 20/04; A47C 19/005; A47C 19/021

(57) ABSTRACT

A bed with multiple separable segments includes a first bed body segment including a first platform part and a first support frame; a second bed body segment including a second platform part and a second support frame; and a third bed body segment connected to the first and second bed body segments and including a third platform part and a third support frame; wherein, the first, second and third platform parts together form a platform for bearing loads and are arranged sequentially in a longitudinal direction of the platform; the first and second support frames are detachably connected with the third support frame in a insertion connection manner. The bed with multiple separable segments of the present disclosure may be separated into multiple bed body segments connected in the insertion connection manner, so that stacking or transportation volume is greatly reduced so as to facilitate storage or transportation.

### FIELD

The present disclosure relates to an electric bed, in particular to a bed with multiple separable segments.

### BACKGROUND

With the improvement of living standards, people in today's society pay more and more attention to their quality of life, and in addition to the requirement on softness and comfort during sleep, people have more and more strict requirement on healthy sleep and also present some requirements on functions for activities. People need adjustable electric beds that can provide free angle adjustments of bed head and feet to improve sleep comfort. For example, when people are, in bed, watching TV, reading books, reading newspapers, or taking a rest or adjusting posture for promoting blood circulation, they need to raise their back or knees at a certain angle, so as to be in a half-lying and half-sitting posture that is comfortable.

Currently, commercially available electric beds are almost integral beds or two-folding beds. The two-folding bed is designed as having two parts that can be folded together. Although, compared to the integral bed, the volume of the two-folding bed has been reduced to a large extent after the two parts of the bed are folded together, the volume of the two-folding bed is still relatively large, and thus the transportation and storage costs are still relatively high. For electric beds of commonly used sizes, the two-folding bed is not suitable to be transported by a family car since it cannot be directly loaded in a trunk of the car.

### SUMMARY

In view of this, the present disclosure provides a bed with multiple separable segments which has a reduced packaging volume to facilitate transportation and storage.

In one aspect, the present disclosure provides a bed with multiple separable segments. The bed comprises a first bed body segment including a first platform part and a first support installed on a bottom side of the first platform part; a second bed body segment including a second platform part and a second support frame installed on a bottom side of the second platform part; and a third bed body segment connected to the first bed body segment and the second bed body segment respectively, and including a third platform part and a third support frame installed on a bottom side of the third platform part; the first platform part, the second platform part and the third platform part together form a platform of the bed for bearing loads, which defines a longitudinal direction and a transverse direction perpendicular to each other, the first platform part, the third platform part and the second platform part are arranged sequentially in the longitudinal direction; and the first support frame and the second support frame are detachably connected with the third support frame in a insertion connection manner, respectively.

In an embodiment, the first support frame and the second support frame are respectively connected with the third support frame in the longitudinal direction in the insertion connection manner, such that the first bed body segment, the second bed body segment and the third bed body segment can be detached in the longitudinal direction to form stackable segments.

In an embodiment, the first support frame includes at least one first longitudinal beam extending in the longitudinal direction, the second support frame includes at least one second longitudinal beam extending in the longitudinal direction, and the third support frame includes at least one third longitudinal beam extending in the longitudinal direction, wherein a longitudinal rear end of each first longitudinal beams forms a first connection end, a longitudinal front end of each second longitudinal beam forms a second connection end, and front and rear ends of each third longitudinal beam forms a third connection end and a fourth connection end respectively; and wherein the first longitudinal beam, the third longitudinal beam and the second longitudinal beam are aligned sequentially in the longitudinal direction, such that the first connection end is detachably connected with the third connection end in the insertion connection manner, and the second connection end is detachably connected with the fourth connection end in the insertion connection manner.

In an embodiment, the at least one first longitudinal beam includes two first longitudinal beams spaced apart from each other in the transverse direction, the at least one second longitudinal beam includes two second longitudinal beams spaced apart from each other in the transverse direction, and the at least one third longitudinal beam includes two third longitudinal beams spaced apart from each other in the transverse direction, such that a transverse distance between the two first longitudinal beams and a transverse distance between the two second longitudinal beams respectively correspond to a transverse distance between the two third longitudinal beams; the first connection end is formed at a longitudinal rear end of the first longitudinal beam, the second connection end is formed at a longitudinal front end of the second longitudinal beam, and the third and fourth connection ends are formed at longitudinal front and rear ends of the third longitudinal beam, such that the two first connection ends are aligned with the two third connection ends in the longitudinal direction, and the two second connection ends are aligned with the two fourth connection ends in the longitudinal direction.

In an embodiment, the third connection end and the fourth connection end respectively extend forward or backward in the longitudinal direction to go beyond the third platform part and are respectively inserted into the corresponding first connection end or the second connection end.

In an embodiment, the first longitudinal beam, the second longitudinal beam and the third longitudinal beam all are square tube-shaped, and an inner cavity of the first connection end is matched with an outer profile of the third connection end in their transverse cross-sectional shape, and an inner cavity of the second connection end is matched with an outer profile of the fourth connection end in their transverse cross-sectional shape.

In an embodiment, the first and third connection ends are provided with corresponding locking holes therein and the second and fourth connection ends are provided with corresponding locking holes therein, and these locking holes are provided for installing fasteners to restrict movement of the first bed body segment and the second bed body segment relative to the third bed body segment in the longitudinal direction.

In an embodiment, the first platform part is a headrest and backrest portion, the third platform part is a buttocks support portion, the second platform part is a leg and foot support portion; and the first platform part includes a first plate portion and a head attachment portion detachably connected to a front end of the first flat part, and the second platform part includes a leg support portion and a foot attachment portion detachably connected to a rear end of the leg support portion.

In an embodiment, the leg support portion includes a thigh support portion and a calf support portion, with the thigh support portion respectively hinged to the second support frame and the calf support portion, and the calf support portion respectively hinged to the thigh support portion and a connecting rod that is hinged to the calf support portion and the second support frame respectively, such the thigh support portion, the calf support portion, and the connecting rod form a four-bar linkage with the second frame provided as a frame.

In an embodiment, the first platform part is hinged to the first support frame, the second platform part is hinged to the second support frame, and the third platform part is fixed to the third support frame; a first actuator is connected between the first platform part and the first support frame for driving the first platform part to move relative to the first support frame, a second actuator is connected between the second platform part and the second support frame for driving the second platform part to move relative to the second support frame, such that the first actuator and the second actuator are staggered in the longitudinal direction.

In an embodiment, the first support frame includes two spaced and parallel first longitudinal beams and a first transverse beam connected between the two first longitudinal beams, and the second support frame includes two spaced and parallel second longitudinal beams and a second transverse beam connected between the two second longitudinal beams; the first actuator is pivotally connected at one end to the first transverse beam, and pivotally connected at the other end to the front end of the first platform part; and the second actuator is pivotally connected at one end to the second transverse beam, and pivotally connected at the other end to the second platform part.

In another aspect, the present disclosure provides a bed with multiple separable segments. The bed defines a longitudinal direction and a transverse direction perpendicular to the longitudinal direction and includes a platform that is used to bear a load of the bed and includes a first platform part, a third platform part and a second platform part arranged sequentially in the longitudinal direction; and a support assembly that is arranged on a bottom side of the platform for supporting the platform, and includes a first support frame, a third support frame and a second support frame detachably connected in the longitudinal direction; wherein the first platform part is connected above the first support frame, the second platform part is connected above the second support frame, and the third platform part is connected above the third support frame.

In an embodiment, the first platform part includes a backrest portion and a head attachment portion detachably connected to a longitudinal front end of the backrest portion, and the second platform part includes a leg support portion and a foot attachment portion detachably connected to a longitudinal rear end of the leg support portion.

In an embodiment, the backrest portion is hinged at its longitudinal rear end to a longitudinal rear end of the first support frame; and a first actuator is connected between the first support frame and the backrest portion, such that opposite ends of the first actuator are respectively connected to the longitudinal front end of the backrest portion and the longitudinal rear end of the first support frame.

In an embodiment, the leg support portion includes a thigh support portion and a calf support portion that are sequentially hinged, such that a longitudinal front end of the thigh support portion is hinged to a longitudinal front end of the second support frame, the foot attachment portion is connected to a longitudinal rear end of the calf support portion, and the rear end of the calf support portion is hinged to the second support frame; a second actuator is connected between the second support frame and the thigh support portion, such that opposite ends of the second actuator are respectively connected to the longitudinal rear end of the thigh support portion and the rear longitudinal end of the second support frame.

In an embodiment, a longitudinal length of an assembly formed by the backrest portion and the first support frame, a longitudinal length of an assembly formed by the leg support portion and the second support frame, and a longitudinal length of an assembly formed by the third platform part and the third support frame is substantially equal to each other.

In summary, the present disclosure provides a bed with multiple separable segments, which can be detached/separated into multiple bed body segments that are connected together in an insertion connection manner to form a complete bed, wherein the platform of the bed is divided into multiple parts, and the support assembly of the bed is divided into three parts that are connected to each other in the insertion connection manner, such that the parts of the platform and the parts of the support assembly can be combined to form a bed body, thereby greatly reducing stacking dimension and package volume to facilitate storage or transportation. Thus, after such a bed of the conventional size is detached, its size is suitable to be directly placed in a family car to provide convenience for customers to purchase, transport and move. The longitudinal beam of the third support frame in the support assembly plays the role of mandrel connection, its two ends are respectively plugged or inserted into the cavities of the first support frame and the second support frame located at the front end and back end respectively, such that multiple bed body segments are integrated, which provides a simple and quick combination. The actuators of the bed are fixed to the support frames of the backrest portion and the leg support portion respectively, and thus it is unnecessary to perform an installation operation for them, which reduces assembly difficulty for customer.

### BRIEF DESCRIPTION OF THE DRAWINGS

FIG. 1 is a perspective view of an assembled bed with multiple separable segments of the present disclosure.

FIG. 2 is an exploded view of the bed of FIG. 1.

FIG. 3 is another exploded view of the bed in FIG. 2.

FIG. 4 is a further exploded view of the bed in FIG. 3.

FIG. 5 is a perspective view of the bed in FIG. 4 but being rotated at a certain angle.

FIG. 6 is a perspective view of a first bed body segment of the bed in FIG. 1.

FIG. 7 is a perspective view of a second bed body segment of the bed in FIG. 1.

FIG. 8 is a perspective view of a third bed body segment of the bed in FIG. 1.

FIG. 9 is a schematic view showing various states of the bed in FIG. 1.

Reference signs in the figures are as follows:

first bed body segment 10 (wherein: first platform part 11, first support frame 12, first actuator 13, first hinge 14; first plate portion 111, head attachment portion 112; first connecting seat 1121; first longitudinal beam 121, first transverse beam 122; first connection end 1211, first locking hole 1211a);

second bed body segment 20 (second platform part 21, second support frame 22, second actuator 23, second hinge 24, connecting rod 25, third hinge 26; thigh support portion 211, calf support portion 212, foot attachment portion 213; second connecting seat 2131; second longitudinal beam 221, second transverse beam 222; second connection end 2211, second locking hole 2211a);

third bed body segment 30 (third platform part 31, third support frame 32; third longitudinal beam 321; third connection end 3211, fourth connection end 3212, third locking hole 3211a, fourth locking hole 3212a).

### DESCRIPTION OF THE EMBODIMENTS

Before describing embodiments in detail, it should be understood that the present disclosure is not limited to the detailed structure or arrangement of elements described below or illustrated in the drawings in the present disclosure. The present disclosure may be embodiments implemented in other ways. Moreover, it should be understood that terms and wordings used herein are only for descriptive purposes and should not be interpreted in a limited manner. The wordings “include”, “comprise”, “have” and the like used herein mean to include items listed thereafter, their equivalents and other additional items. In particular, when describing “a/an” element, the present disclosure does not intend to limit the number of the element to one, but may include multiple elements.

The disclosure provides a bed detachably assembled by multiple bed body segments which are configured to be connected to each other to form a complete bed together. For storage and/or transportation purposes, the bed body segments can be separated from each other and then stacked together to thereby reduce packaging volume of the bed. Embodiments of the present disclosure will be described in details by taking a bed with three bed body segments as an example. It should be understood that the bed of the present disclosure may also have more than three bed body segments.

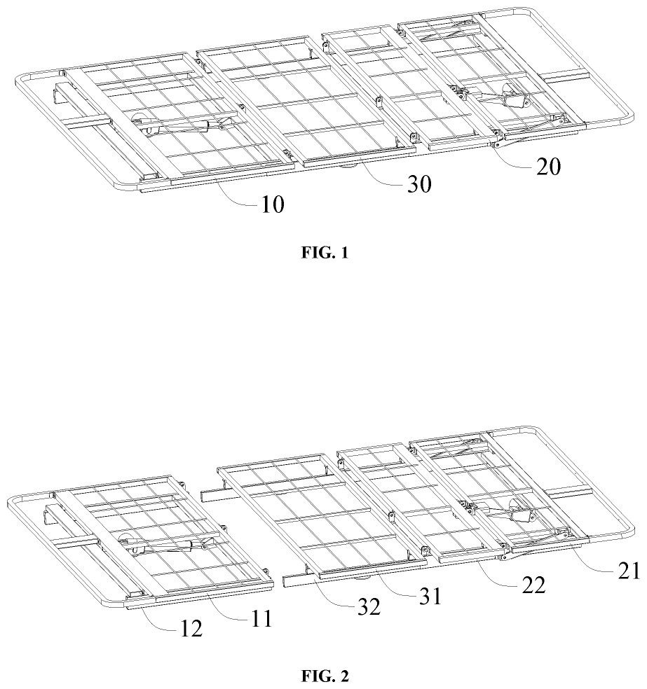

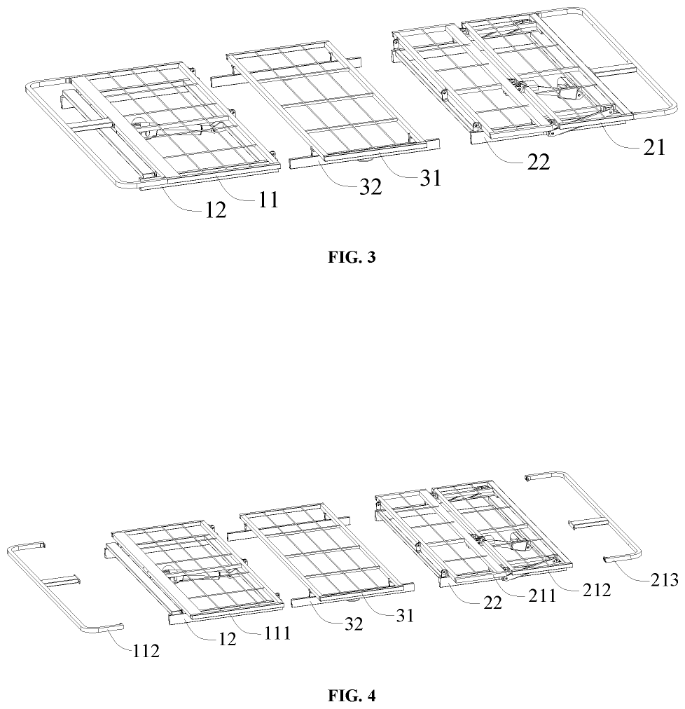

Referring to FIGS. 1 to 4, the present disclosure provides a bed which, after be disassembled, has a greatly reduced packaging volume compared with conventional electric beds, and thus has a size convenient for transportation and storage. The bed includes a platform and a support assembly for supporting the platform. The bed and its platform define a longitudinal direction and a transverse direction perpendicular to the longitudinal direction. The platform is configured to support a load, such as a human body. Usually, a mattress is placed on the platform during use. Further, the bed may also include a plurality of support legs (not shown) that are installed to the support assembly.

In the illustrated embodiment, the bed includes a first bed body segment 10, a second bed body segment 20 and a third bed body segment 30. In an embodiment shown in FIGS. 1 to 4, the first bed body segment 10, the third bed body segment 30 and the second bed body segment 20 are arranged sequentially in the longitudinal direction, and are detachably connected to each other.

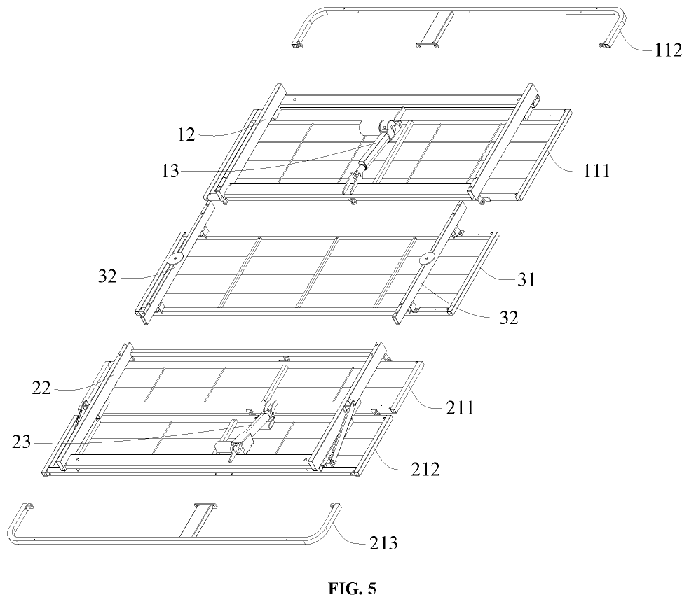

Referring also to FIGS. 5 to 7, the first bed body segment 10 includes a first platform part 11 and a first support frame 12 installed on a bottom side of the first platform part 11. The second bed body segment 20 includes a second platform part 21 and a second support frame 22 installed on a bottom side of the second platform part 21. The third bed body segment 30 includes a third platform part 31 and a third support frame 32 installed on a bottom side of the third platform part 31. In the illustrated embodiment, the first platform part 11, the second platform part 21 and the third platform part 31 together form the platform of the bed. The first support frame 12, the second support frame 22 and the third support frame 31 together form the support assembly of the bed. In other words, the bed may be divided into three bed body segments, for example, the first bed body segment 10, the second bed body segment 20 and the third bed body segment 30. The first bed body segment 10 including the first platform part 11 and the first support frame 12, may further include a number of support legs installed to the first support frame 12. The second bed body segment 20 including the second platform part 21 and the second support frame 22, may further include a number of support legs installed to the second support frame 22. The third bed body segment 30 including the third platform part 31 and the third support frame 32 may also include a number of support legs installed to the third support frame 32. These support legs are used as a supporting structure to support the platform at a predetermined distance from the ground. It can be understood that, in other embodiments, the support structure may also be implemented in other forms, such as a support frame with a height adjustment function (for example, a scissor or cross brace).

The first platform part 11 of the first bed body segment 10 is a headrest portion, the second platform part 21 of the second bed body segment 20 is a leg and foot support portion, and the third platform part 31 of the third bed body segment 30 is a buttocks support portion. The first bed body segment 10, the second bed body segment 20 and the third bed body segment 30 are combined into a complete bed, which may also be detached into three independent segments. In a combined state, the first platform part 11, the third platform part 31 and the second platform part 21 are connected sequentially in the longitudinal direction to form the platform for supporting loads; in a detached state, the first bed body segment 10, the second bed body segment 20 and the third bed body segment 30 may be stacked one on top of another, and a head attachment portion 112 of the first bed body segment 10 and a foot attachment portion 213 of the second bed body segment 20 may be detached and stacked separately, such that the stack has a length less than one third of an overall longitudinal length of the bed and a thickness less than three times a thickness of the bed.

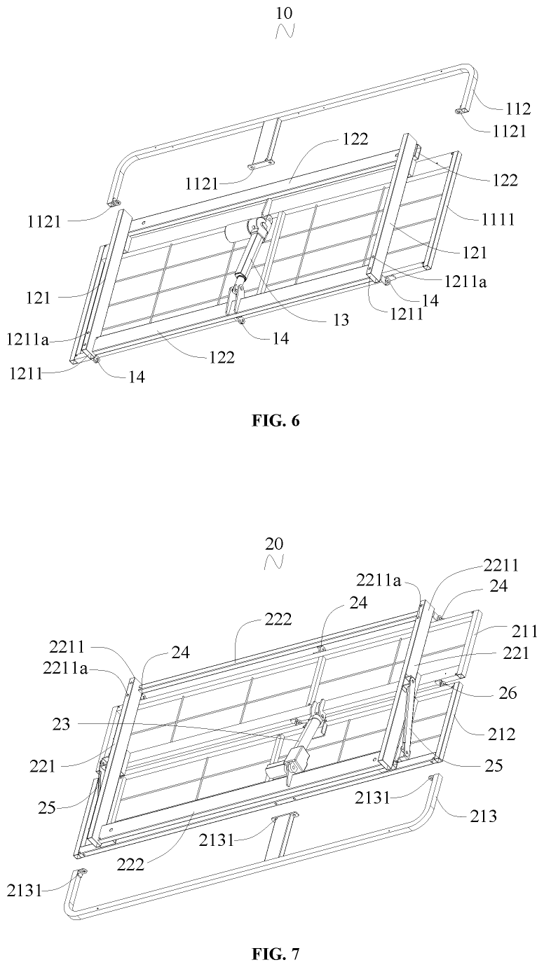

As shown in FIG. 5, the first platform part 11 includes a first plate portion 111 (i.e., a backrest portion) and the head attachment portion 112 connected to the first plate portion 111, and the first plate portion 111 is hinged at its longitudinal rear end to the first support frame 12 through a plurality of first hinges 14 (see FIG. 6) having a hinge axis arranged in the transverse direction, such that the first platform part 11 may be pivotable and lifted upward relative to the first support frame 12 around the transversely arranged hinge axis of the first hinge 14. The head attachment portion 112 is detachably connected to a front end of the first plate portion 111 through a plurality of first connecting seats 1121 provided at its rear end. Specifically, the head attachment portion 112 is secured to the first plate portion 111 by fasteners extending through the first connecting seat 1121 to be engaged in corresponding connecting holes defined in the front end of the first plate portion 111. The fasteners may be screws or threads.

In the illustrated embodiment, the first support frame 12 includes two spaced and parallel first longitudinal beams 121 and a plurality of first transverse beams 122 connected between the two first longitudinal beams 121. The two first longitudinal beams 121 extend in the longitudinal direction of the bed and are spaced apart from each other in the transverse direction of the bed.

Referring to FIG. 5 and FIG. 7, the second platform part 21 includes a thigh support portion 211, a calf support portion 212 rotatably connected to the thigh support portion 211, and a foot attachment portion 213. The thigh support portion 211 is hinged at its longitudinal front end to the second support frame 22 through a plurality of second hinges 24 having a hinge axis arranged in the transverse direction, such that the thigh support portion 211 may be lifted upward relative to the second support frame 22 around the transversely arranged hinge axis of the second hinge 24. The calf support portion 212 is hinged at its front end to a rear end of the thigh support portion 211 through a plurality of third hinges 26, and is connected at its rear end to the second support frame 22 through a plurality of connecting rods 25. Each connecting rod 25 is rotatably connected at one end thereof to the calf support portion 212, and is rotatably connected at the other end to the second support frame 22. The foot attachment portion 213 is detachably connected to the rear end of the calf support portion 212 through a plurality of second connecting seats 2131 provided at its front end. Specifically, the foot attachment portion 213 is installed to the calf support portion 212 by inserting fasteners through the second connecting seat 2131 and engaging the fastener into corresponding connecting holes defined in the rear end of the calf support portion 212.

Referring to FIG. 5, FIG. 6 and FIG. 7, in this embodiment, the first bed body segment 10 includes a first actuator 13, and the second bed body segment 20 includes a second actuator 23. The first actuator 13 is connected between the first platform part 11 and the first support frame 12 for driving the first platform part 11 to move relative to the first support frame 12. The second actuator 23 is connected between the second platform part 21 and the second support frame 22 for driving the second platform part 21 to move relative to the second support frame 22. In the illustrated embodiment, the first actuator 13 and the second actuator 23 are staggered in the longitudinal direction to avoid any interference between them during stacking the detached segments.

In the illustrated embodiment, the first platform part 11, the second platform part 21 and the third platform part 31 are not directly connected to each other. The first support frame 12 and the second support frame 22 are connected with the third support frame 32 in an insertion connection manner, respectively, and a insertion connection is respectively formed between the rear end of the first support frame 12 and the front end of the third support frame 32 and between the front end of the second support frame 22 and the rear end of the third support frame 32. The first plate portion 111 is hinged to the first support frame 12; the thigh support portion 211 is hinged to the second support frame 22, the calf support portion 212 is rotatably connected to the thigh support portion 211 and the connecting rod 25, and the connecting rod 25 is hinged to the second support frame 22, such that the thigh support portion 211, the calf support portion 212, the connecting rod 25 and the second support frame 22 form a four-bar linkage in a plane parallel to the longitudinal direction with the second support frame 22 provided as a frame (fixed bar). More specifically, the thigh support portion 211, the calf support portion 212, the connecting rod 25 and the second support frame 22 form a parallelogram linkage in the plane parallel to the longitudinal direction with the second support frame 22 as the frame, such that when the second actuator 23 drives the second bed body segment 20 to move, the calf support portion 212 is always kept parallel to the second support frame 22 in the longitudinal direction.

The second support frame 22 includes two spaced and parallel second longitudinal beams 221 and at least one second transverse beam 222 connected between the two second longitudinal beams 221. The two second longitudinal beams 221 extend in the longitudinal direction of the bed and spaced apart from each other in the transverse direction of the bed.

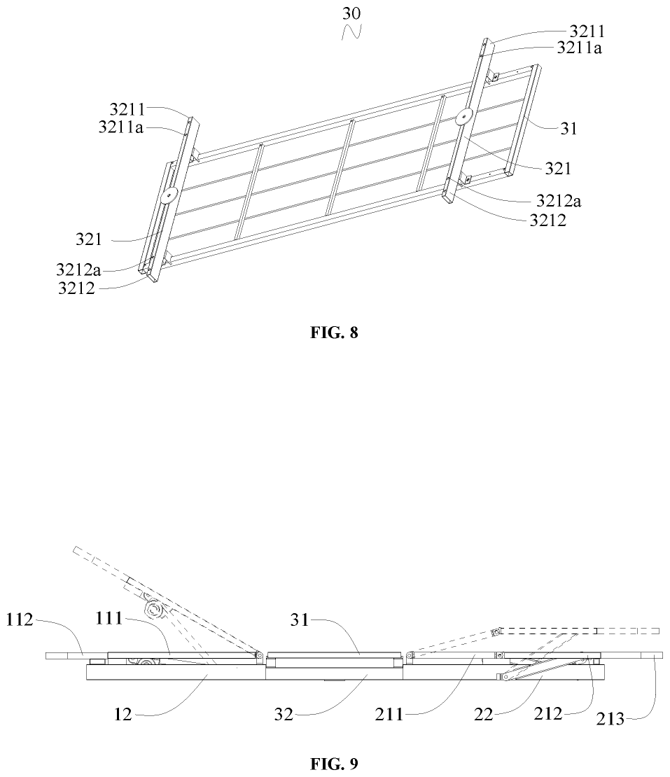

As shown in FIG. 8, the third support frame 32 includes two spaced and parallel third longitudinal beams 321, and the two third longitudinal beams 321 extend in the longitudinal direction of the bed and are spaced apart from each other in the transverse direction of the bed. The third platform part 31 is fixed to the third support frame 32. The third support frame 32 is provided with no transverse beam; in other embodiments, the third support frame 32 may also be provided with one or more third transverse beams between the two third longitudinal beams 321 to further increase structural strength of the third support frame 32.

In the illustrated embodiment, a transverse distance between the two first longitudinal beams 121 and a transverse distance between the two second longitudinal beams 221 are matched with a transverse distance between the two third longitudinal beams 321, such that when the first bed body segment 10 and the second bed body segment 20 are connected with the third bed body segment 30 in the insertion connection manner from opposite ends of the third bed body segment 30, the first longitudinal beam 121 of the first support frame 12 and the second longitudinal beam 221 of the second support frame 22 are respectively aligned with the third longitudinal beam 321 of the third support frame 32, and such that the first longitudinal beam 121 of the first support frame 12 and the second longitudinal beam 221 of the second support frame 22 may be completely connected together with the corresponding third longitudinal beams 321 of the third support frame 32 in the insertion connection manner, respectively. In other embodiments, the first support frame 12 may include one first longitudinal beam 121 or more than two first longitudinal beams 121, and the second support frame 22 may include one second longitudinal beam 221 or more than two second longitudinal beams 221, and accordingly, the third support frame 32 may include one third longitudinal beam 321 or more than two third longitudinal beams 321.

Each first longitudinal beam 121 has a first connection end 1211 at the rear end thereof, and each second longitudinal beam 221 has a second connection end 2211 at the front thereof. The third longitudinal beam 321 has a third connection end 3211 and a fourth connection end 3212 at the front and rear ends thereof, respectively. The first connection end 1211 and the corresponding third connection end 3211 are connected with each other in the longitudinal direction in the insertion connection manner, and the second connection end 2211 and the corresponding fourth connection end 3212 are connected with each other in the longitudinal direction in the insertion connection manner. The first connection end 1211 of each first longitudinal beam 121, the second connection end 2211 of each second longitudinal beam 221 and the third connection end 3211 and forth connection end 3212 of the corresponding third longitudinal beam 321 are aligned with each other in the longitudinal direction, that is, there is no offset in the longitudinal direction. Specifically, the third connection end 3211 of each third longitudinal beam 321 is inserted into a cavity formed in the first connection end 1211 of the corresponding first longitudinal beam 121, and the fourth connection end 3212 of each third longitudinal beam 321 is inserted into a cavity formed in the second connection end 2211 of the corresponding second longitudinal beam 221. That is, the first connection end 1211 of the first longitudinal beam 121 and the second connection end 2211 of the second longitudinal beam 221 act as sockets while the third connection end 3211 and the fourth connection end 3212 of the corresponding third longitudinal beam 321 act as plugs. It is understood that in other embodiments, the first connection end 1211 of the first longitudinal beam 121 and the second connection end 2211 of the second longitudinal beam 221 may be inserted into the third connection end 3211 and the fourth connection end 3212 of the corresponding third longitudinal beam 321 as required. In the illustrated embodiment, the first longitudinal beam 121, the second longitudinal beam 221 and the third longitudinal beam 321 all have a square hollow tube structure, with a shape of the first connection end 1211 matched with that of the third connection end 3211, and a shape of the connection end 2211 matched with that of the fourth connection end 3212. The first connection end 1211 and the third connection end 3211 are respectively provided with corresponding first and third locking holes 1211a, 3211a, and the second connection end 2211 and the fourth connection end 3212 are provided with corresponding second and fourth locking holes 2211a, 3212a. After the insertion connection is established, a fastener (e.g., a screw, a pin or the like) may be inserted into the aligned first locking hole 1211a and third locking hole 3211a as well as the second locking hole 2211a and the fourth locking hole 3212a from below, so as to lock/fix the insertion connection of the first longitudinal beam 121, the second longitudinal beam 221 and the third longitudinal beam 321, avoiding any relative movement of the first bed body segment, the second bed body segment and the third bed body segment in the longitudinal direction and making connection more reliable.

Considering dimension relationship between the platform part of each bed body segment and the corresponding part of a human body, in the illustrated embodiment, the third longitudinal beam 321 has a longitudinal length greater than that of the third platform part 31, that is, both the front and rear ends of the third longitudinal beam 321 longitudinally protrude from the third platform part 31, the rear end of the first longitudinal beam 121 does not go beyond or slightly goes beyond the first hinge 14 provided at the rear end of the first platform part 11, and the front end of the second longitudinal beam 221 does not go beyond or slightly goes beyond the second hinge 24 provided at the front end of the second platform part 21, such that the detached first bed body segment 10 (with the head attachment portion 112 removed), second bed body segment 20 (with the foot attachment portion 213 removed) and third bed body segment 30 have substantially the same longitudinal dimensions, that is, a longitudinal length of the assembly formed by the backrest portion and the first support frame 12, a longitudinal length of the assembly formed by the leg support portion and the second support frame 22, and a longitudinal length of the assembly formed by the third platform part 31 (buttocks support portion) and the third support frame 32 are substantially equal to each other, so that the longitudinal dimension of the stack can be reduced. In addition, since the first actuator 13 and the second actuator 23 are staggered in the longitudinal direction to avoid any interference during stacking the detached segments, the thickness of the three stacked segments can be reduced.

The insertion connection of the first support frame 12, the second support frame 22 and the third support frame 32 may be realized in a variety of ways. For example, it is also possible to use a shaft-opening type of insertion connection way. In the illustrated embodiment, the platform parts of the bed can be lifted to provide a more comfortable position for the user. The first plate portion 111 of the first bed body segment 10 provides support for the back, the thigh support portion 211 and calf support portion 212 of the second bed body segment 20 provide support for the legs, and the third platform part 31 of the third bed body segment 30 provides support for the buttocks. The third platform part 31 keeps stationary relative to the support assembly during the lifting operation of the backrest portion and the thigh/calf support portion. FIG. 9 shows various states of the platform including a flat configuration, a head end lifted configuration and a foot end lifted configuration.

Referring to FIG. 6, two first transverse beams 122 are connected between the two first longitudinal beams 121 at opposite ends of the two first longitudinal beams 121 respectively. The first actuator 13 is pivotally connected at one end to a rear end of the first transverse beam 122, and pivotally connected at the other end to the front end of the first platform part 11. The first actuator 13 can control/drive the first platform part 11 including the first plate portion 111 and the head attachment portion 112 to lift up relative to the first support frame 12, as shown by dotted lines in FIG. 9.

Referring to FIG. 7, two second transverse beams 222 are connected to opposite ends of the two second longitudinal beams 221. The second actuator 23 is pivotally connected at one end to a rear end of the second transverse beam 222, and pivotally connected at the other end to the rear end of the thigh support portion 211 of the second platform part 21. The second actuator 23 may be operated to lift the thigh support portion 211 and thus the calf support portion 212 and foot attachment portion 213 hinged to the thigh support portion, as shown by dotted lines in FIG. 9. During lifting the second platform part 21, the thigh support portion 211 rotates upward relative to the second support frame 22 (and the third platform part 31) in a plane parallel to the longitudinal direction, and the calf support portion 212 is lifted obliquely upward and parallel in the longitudinal direction relative to the second support frame 22. In the illustrated embodiment, there are two connecting rods 25. Each connecting rod 25 is pivotally connected at one end to the rear end of the calf support portion 212 of the second platform part 21, and pivotally connected at the other end to the outer side of the corresponding second longitudinal beam 221.

In summary, the present disclosure provides a multi-segment detachable and combinable bed, which can be detached/divided into multiple bed body segments that are connected in the insertion connection manner together to form a complete bed, e.g., there are three bed body segments (i.e., the first bed body segment, the second bed body segment and the third bed body segment) which may be connected in the insertion connection manner. Among of them, the platform of the bed is divided into three parts (i.e., the headrest and backrest portion, the buttocks support portion and the leg and foot support portion), five portions (the head attachment portion, the back support portion, the third platform part, the foot support portion and the foot attachment portion); and the support assembly of the bed is divided into three parts (the first support frame, the third support frame and the second support frame), such that the parts of the platform and the parts of the support assembly can be combined to form the bed body, thereby greatly reducing stacked dimension and package volume to facilitate storage or transportation. Thus, after such a bed of the conventional size is detached, its size is suitable to be directly placed in a family car to provide convenience for customers to purchase, transport and move. The longitudinal beams of the third support frame in the support assembly plays the role of mandrel connection, its two ends are respectively plugged or inserted into the first support frame and the second support frame located at the front end and back end respectively, so that the multiple bed body segments are integrated, which provides a simple and quick combination. The actuators (electrical components) of the bed are fixed on the support frames corresponding to the backrest portion and the leg support portion respectively, and thus it is unnecessary to perform an installation operation for them, which reduces assembly difficulty for customer.

The concepts described herein can be implemented in other forms without departing from its spirit and characteristics. The specific embodiments as disclosed should be regarded as illustrative rather than restrictive. Therefore, the scope of the present disclosure is determined by the appended claims instead of the foregoing description. Any changes within the literal meaning and equivalent scope of the claims shall fall within the scope of these claims.

What is claimed is:

1. A bed comprising:
a first bed body segment comprising a first platform part and a first support frame installed on a bottom side of the first platform part;
a second bed body segment comprising a second platform part and a second support frame installed on a bottom side of the second platform part; and
a third bed body segment connected to the first bed body segment and the second bed body segment respectively, the third bed body segment comprising a third platform part and a third support frame installed on a bottom side of the third platform part;
wherein the first platform part, the second platform part and the third platform part cooperatively form a platform of the bed for bearing loads, the platform defines a longitudinal direction and a transverse direction perpendicular to each other, the first platform part, the third platform part and the second platform part are arranged sequentially in the longitudinal direction, and each of the first support frame and the second support frame is detachably connected with the third support frame in an insertion connection manner.

2. The bed according to claim 1, wherein each of the first support frame and the second support frame is connected with the third support frame in the longitudinal direction via the insertion connection manner, such that the first bed body segment, the second bed body segment and the third bed body segment can be detached in the longitudinal direction to form stackable segments.

3. The bed according to claim 2, wherein the first support frame comprises at least one first longitudinal beam extending in the longitudinal direction, the second support frame comprises at least one second longitudinal beam extending in the longitudinal direction, and the third support frame comprises at least one third longitudinal beam extending in the longitudinal direction, wherein a longitudinal rear end of the at least one first longitudinal beam forms a first connection end, a longitudinal front end of the at least one second longitudinal beam forms a second connection end, and front and rear ends of the at least one third longitudinal beam forms a third connection end and a fourth connection end respectively; and wherein the first longitudinal beam, the third longitudinal beam and the second longitudinal beam are aligned sequentially in the longitudinal direction, such that the first connection end is detachably connected with the third connection end via the insertion connection manner, and the second connection end is detachably connected with the fourth connection end via the insertion connection manner.

4. The bed according to claim 3, wherein the at least one first longitudinal beam comprises two first longitudinal beams spaced apart from each other in the transverse direction, the at least one second longitudinal beam comprises two second longitudinal beams spaced apart from each other in the transverse direction, and the at least one third longitudinal beam comprises two third longitudinal beams spaced apart from each other in the transverse direction, such that a transverse distance between the two first longitudinal beams and a transverse distance between the two second longitudinal beams respectively correspond to a transverse distance between the two third longitudinal beams so as to align the two first connection ends with the two third connection ends in the longitudinal direction, and align the two second connection ends with the two fourth connection ends in the longitudinal direction.

5. The bed according to claim 4, wherein the third connection end and the fourth connection end respectively extend forward or backward in the longitudinal direction to go beyond the third platform part and are respectively inserted into the corresponding first connection end or the second connection end.

6. The bed according to claim 5, wherein the first longitudinal beam, the second longitudinal beam and the third longitudinal beam all are square tube-shaped, and an inner cavity of the first connection end is matched with an outer profile of the third connection end in their transverse cross-sectional shape, and an inner cavity of the second connection end is matched with an outer profile of the fourth connection end in their transverse cross-sectional shape.

7. The bed according to claim 3, wherein the first and third connection ends are provided with corresponding locking holes, and the second and fourth connection ends are provided with corresponding locking holes therein, and the locking holes are provided to install fasteners to restrict movement of the first bed body segment and the second bed body segment relative to the third bed body segment in the longitudinal direction.

8. The according to claim 1, wherein the first platform part is a headrest and backrest portion, the third platform part is a buttocks support portion, the second platform part is a leg and foot support portion; and the first platform part comprises a first plate portion and a head attachment portion detachably connected to a front end of the first flat part, the second platform part comprises a leg support portion and a foot attachment portion detachably connected to a rear end of the leg support portion.

9. The bed according to claim 8, wherein the leg support portion comprises a thigh support portion and a calf support portion, with the thigh support portion respectively hinged to the second support frame and the calf support portion, and the calf support portion respectively hinged to the thigh support portion and a connecting rod that is hinged to the calf support portion and the second support frame respectively, such that the second frame, the thigh support portion, the calf support portion and the connecting rod cooperatively form a four-bar linkage with the second frame acting as a frame of the four-bar linkage.

10. The bed according to claim 1, wherein the first platform part is hinged to the first support frame, the second platform part is hinged to the second support frame, and the third platform part is fixed to the third support frame; a first actuator is connected between the first platform part and the first support frame for driving the first platform part to move relative to the first support frame, a second actuator is connected between the second platform part and the second support frame for driving the second platform part to move relative to the second support frame, and the first actuator and the second actuator are staggered in the longitudinal direction.

11. The bed according to claim 10, wherein the first support frame comprises two spaced and parallel first longitudinal beams and a first transverse beam connected between the two first longitudinal beams, and the second support frame comprises two spaced and parallel second longitudinal beams and a second transverse beam connected between the two second longitudinal beams; the first actuator is pivotally connected at one end to the first transverse beam, and pivotally connected at the other end to the front end of the first platform part, and the second actuator is pivotally connected at one end to the second transverse beam, and pivotally connected at the other end to the second platform part.

12. A bed which defines a longitudinal direction and a transverse direction perpendicular to the longitudinal direction, comprising:
a platform that is configured to bear a load of the bed and comprises a first platform part, a third platform part and a second platform part arranged sequentially in the longitudinal direction; and
a support assembly that is arranged on a bottom side of the platform for supporting the platform, and comprises a first support frame, a third support frame and a second support frame detachably connected in the longitudinal direction;
wherein the first platform part is connected above the first support frame, the second platform part is connected above the second support frame, and the third platform part is connected above the third support frame.

13. The bed according to claim 12, wherein the first platform part comprises a backrest portion and a head attachment portion detachably connected to a longitudinal front end of the backrest portion, and the second platform part comprises a leg support portion and a foot attachment portion detachably connected to a longitudinal rear end of the leg support portion.

14. The bed according to claim 13, wherein the backrest portion is hinged at its longitudinal rear end to a longitudinal rear end of the first support frame; and a first actuator is connected between the first support frame and the backrest portion, such that opposite ends of the first actuator are respectively connected to the longitudinal front end of the backrest portion and the longitudinal rear end of the first support frame.

15. The bed according to claim 13, wherein the leg support portion comprises a thigh support portion and a calf support portion that are sequentially hinged, such that a longitudinal front end of the thigh support portion is hinged to a longitudinal front end of the second support frame, the foot attachment portion is connected to a longitudinal rear end of the calf support portion, and the rear end of the calf support portion is hinged to the second support frame; a second actuator is connected between the second support frame and the thigh support portion, such that opposite ends of the second actuator are respectively connected to the longitudinal rear end of the thigh support portion and the rear longitudinal end of the second support frame.

16. The bed according to claim 12, wherein a longitudinal length of an assembly formed by the backrest portion and the first support frame, a longitudinal length of an assembly formed by the leg support portion and the second support frame, and a longitudinal length of an assembly formed by the third platform part and the third support frame is substantially equal to each other.

17. The bed according to claim 12, wherein the first platform part is a headrest and backrest portion, the third platform part is a buttocks support portion, the second platform part is a leg and foot support portion; and the first platform part comprises a first plate portion, the second platform part comprises a leg support portion which comprises a thigh support portion and a calf support portion, the thigh support portion being hinged to the second support frame and the calf support portion respectively and a connecting rod being hinged to the calf support portion and the second support frame respectively such that the second frame, the thigh support portion, the calf support portion and the connecting rod cooperatively form a four-bar linkage with the second frame acting as a frame of the four-bar linkage.
